(19) United States
(12) Patent Application Publication
(10) Pub. No.: US 2009/0217531 A1
(43) Pub. Date: Sep. 3, 2009

(54) ELECTRIC SHAVER

(76) Inventor: Katsumi MURAGUCHI, Kasai-shi (JP)

Correspondence Address: ECKERT SEAMANS CHERIN & MELLOTT, 600 GRANT STREET, 44TH FLOOR, PITTSBURGH, PA, 15219, US

(21) Appl. No.: 12/393,191

(22) Filed: Feb. 26, 2009

(30) Foreign Application Priority Data
Feb. 28, 2008 (JP) 2008-47093

(51) Int. Cl. B26B 19/28; B26B 21/52

(52) U.S. Cl. 30/45; 30/527

(57) ABSTRACT

An electric shaver which can be pulled for shaving. The shaver comprises a head 2 tiltably attached to an end of a handle 1 and having a blade unit 3. The head 2 is tiltable with the handle 1 thereby supported vertically until the blade unit 3 is positioned sideways, and is holdable as positioned sideways by lock means 6. When the head 2 is positioned sideways, the shaver can be pulled for shaving.

This application claims priority from Japanese Patent Application No. 2008-47093, filed Feb. 28, 2008, which is hereby incorporated by reference herein.

### TECHNICAL FIELD

The present invention relates to electric shavers comprising a head having a blade unit and a handle supporting the head thereon tiltably.

### BACKGROUND OF THE INVENTION

Electric shavers are available which comprise a head having a blade unit, and a handle tiltably supporting the head thereon so as to alter the angle of the razor blade relative to the handle (see, for example, Japanese Utility Model Publication No. 6372/1986).

With the electric shaver mentioned above, the head is very small in the maximum inclination from the handle, and the shaver is used with the handle pushed toward the head (hereinafter referred to as “pressure shaving.”

In pressure shaving, the blade tends to be pressed against the skin with a pressure greater than is necessary, causing the skin to feel irritated after shaving. Additionally, since the hand is moved with the elbow unconsciously raised nearly to the shoulder level, the user is likely to feel muscular fatigue.

The present invention provides an electric shaver which is usable for shaving by pulling (hereinafter referred to as “pull shaving”) like T-shaped safety razors, whereas this mode of shaving is inconceivable with conventional electric shavers.

### SUMMARY OF THE INVENTION

The present invention provides an electric shaver comprising a head tiltably attached to one end of a handle, the head having a blade unit,

the head being tiltable with the handle thereby supported vertically until the blade unit is positioned sideways, the head being holdable as positioned sideways by lock means.

With the head positioned generally sideways relative to the handle, the electric shaver is usable for shaving by pulling the handle and slidingly moving the head along the face.

This mode of pull shaving eliminates the likelihood that the blade will be forced against the skin with a pressure greater than is needed, preventing the skin from smarting. The construction described reduces muscular burdens because there is no need to apply a force greater than is necessary and further because the shaver is usable without raising the elbow nearly to the level of the shoulder.

The head can be held tilted by the lock means, so the shaver is usable with safety without altering the angle of the head during use.

With the electric shaver described, the handle can be in the form of a shaft and enlarged into a generally T-shaped portion toward the head, the enlarged portion having bracket arms projecting respectively from opposite ends thereof, the head being provided between the bracket arms.

Since the handle of the shaver is in the form of a shaft, the shaver can be held like the conventional T-shaped safety razor when the shaver is used for shaving the underside of the chin or the side of the face by pulling the shaver upward from below. The shaver is therefore easy to use.

With the electric shaver described, the head can be locked in a plurality of tilted positions including a pull shaving tilted position which is a basic tilted position permitting the blade unit to be positioned sideways with the handle supported vertically and a border shaving tilted position permitting the blade unit to face generally upward.

When the head is in the border shaving tilted position, sideburns or like whiskers can be shaven off as by conventional electric shavers.

With the electric shaver described, the head in the pull shaving tilted position can be inclined through about 80 degrees from an extension of the axis P1 of the handle extending through the head, and the head in the border shaving tilted position can be inclined through about 20 degrees from the extension.

When the head is brought to the border shaving tilted position, sideburns or like whiskers can be shaven off as by conventional electric shavers.

With the electric shaver described, the handle has an eccentric rotary shaft projecting from the end thereof and coupled to a motor, and the head is tiltably provided between bracket arms projecting respectively from opposite sides of the end of the handle, the head comprising a head body case having a bottom portion adjacent the handle and curved toward the direction of tilting of the head, an outer blade cassette removably provided in the head body case, a vibrator reciprocatingly movable in directions orthogonal to the handle and engaging with the eccentric rotary shaft as loosely inserted through a bottom plate of the head body case, and inner blades slidable in contact with outer blades of an outer blade cassette from inside thereof and attached to and reciprocatingly movable with the vibrator, the vibrator having parallel guide plates orthogonal to the directions of reciprocation of the vibrator, the eccentric rotary shaft being interposed between and slidable in contact with the guide plates, each of the guide plates having a circular-arc edge extending along the curve of the head body bottom portion, a closing piece projecting outward from each of the guide plates and extending along the circular-arc edge, the bottom plate of the head having a slip with a width to avoid the interference of the bottom plate with the eccentric rotary shaft, the closing piece serving to close the slit even when the vibrator oscillates widthwise of the slit.

The vibrator has parallel guide plates having the eccentric rotary shaft positioned therebetween and slidable in contact therewith. The guide plates each have a circular-arc edge which is curved in the direction of rotation of the head and opposed to the bottom plate of the head body case from inside. Since the bottom plate has a slit for preventing the bottom plate from interfering with the eccentric rotary shaft, the head is tiltable free of any trouble.

When the vibrator oscillates toward the slit portion, the closing pieces projecting from the respective guide plates cover the slit, obviating the likelihood of fragments of beard or like extraneous matter from moving into or out of the slit.

Furthermore, the closing pieces serve as reinforcement ribs for the guide plates, contributing to a reduction in the thickness of the guide plates.

With the handle positioned vertically and with the head on an upper end of the handle positioned sideways, the blade unit preferably has a border shaving outer blade, a rough shaving outer blade and a finish shaving outer blade which are arranged from below upward in this order, the outer blades having respective outer faces positioned generally on a plane F, and the plane F makes an angle of 10 to 20 degrees with an axis P1 of the handle, the finish shaving outer blade being remotest in position from the axis P1.

In pull shaving, it is possible to shave off a twisted long beard with the border shaving outer blade first, to roughly shave off an ordinarily grown beard with the rough shaving outer blade and to use the finish shaving outer blade for finishing. This assures effective shaving with a reduced likelihood of leaving some beard unshaven.

The border shaving outer blade, rough shaving outer blade and finish shaving outer blade have their outer faces arranged generally in a plane F, and the plane F is inclined at an angle of 10 to 20 degrees from the axis P1 of the handle so that the finish shaving outer blade is highest from the axis P1. Accordingly, all the blades are spontaneously brought into contact with the skin during pull shaving to realize an effective shave.

With the electric shaver described, the head body case preferably has a front wall facing toward the pull shaving tilted position and provided with a push knob for pushing up a border shaving outer blade to a border shaving position, and a rear wall provided with a washing window and a lid for closing the window.

When a flow of water is applied to the head body case from above with the washing window opened, the water is discharged from between the blades positioned sideways, whereby the shaver is washed effectively.

The border shaving outer blade has larger perforations than the rough shaving outer blade and finish shaving outer blade. Since the washing window is provided on the backside of the head body case, i.e., at a position remotest from the border shaving outer blade having the largest perforations, the flow of water applied to the head body case spreads over the entire interior of the body case to fully wash the shaver, and is then run off from the blade perforations and other clearances. This ensures effective cleaning by merely applying running water.

When the handle is grasped with its front side down and with the head in the border shaving tilted position, the washing window faces upward with the outer blades positioned sideways, so that the washings flow out sideways away from the handle. This eliminates the likelihood of the water splashing over the handle or the hand.

### BRIEF DESCRIPTION OF THE DRAWINGS

FIG. 1 is a perspective view of an electric shaver as it is seen from the front;

FIG. 2 shows a head in tilted positions, (a) being a tilted position for pull shaving, (b) being an intermediate tilted position, (c) being a border shaving tilted position;

FIG. 3 is a perspective view of the backside of the head of the shaver;

FIG. 4 is an exploded perspective view of the head;

FIG. 5(a) is a plan view of the head, and FIG. 5(b) is a front view of the upper portion of a handle;

FIG. 6(a) is a side elevation of the head, and FIG. 6(b) is a side elevation of the handle upper portion;

FIG. 7 is an exploded perspective view of lock means on the handle;

FIG. 8 is an exploded side elevation of the lower portion of the head;

FIG. 9 is an exploded perspective view of a blade unit;

FIG. 10 is a an exploded perspective view of an outer blade cassette;

FIG. 11 is a sectional view of the lock means in a head locking state;

FIG. 12 is a sectional view of the lock mans in a head unlocking state;

FIG. 13 is a perspective view of a vibrator as it is seen from below;

FIG. 14 is a sectional view showing the relationship between the vibrator and a slit in the head;

FIG. 15 is a sectional view showing the vibrator and the vicinity thereof;

FIG. 16(a) is a perforation pattern of an outer blade for finish shaving, and FIG. 16(b) is an enlarged view of the perforation pattern;

FIG. 17(a) is a perforation pattern of rough shaving outer blade, and FIG. 17(b) is an enlarged view of the perforation pattern;

FIG. 18 is an illustration of the shaver as it is used for the pull shaving of the lower part of the chin;

FIG. 19 is an illustration of the shaver as it is used for the pull having of one side the face; and

FIG. 20 is an illustration showing how to wash the interior of the head.

### DESCRIPTION OF THE PREFERRED EMBODIMENT

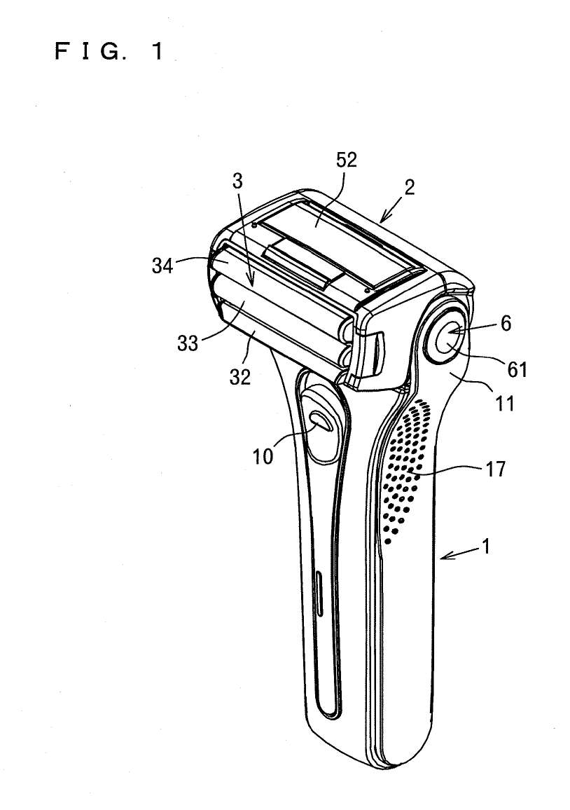

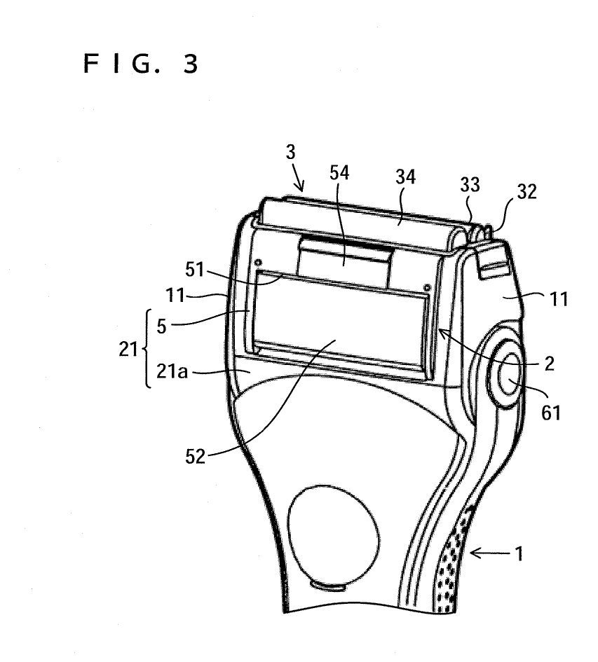

With reference to FIGS. 1 and 3, the present invention provides an electric shaver, which comprises a head 2 having a blade unit 3 and tiltably supported between bracket arms 11, 11 projecting from opposite sides of one end of a handle 1. The head 2 can be held in a plurality of tilted positions by lock means 6.

A power supply switch 10 is provided at an upper portion of center of the front wall of the handle 1.

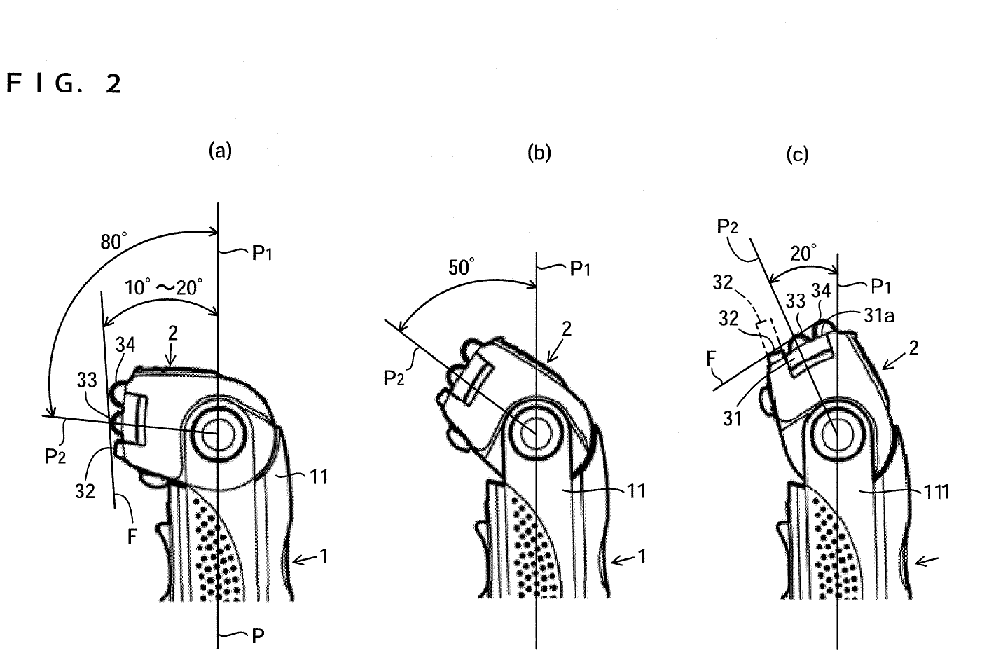

FIG. 2 shows the tilted rocked positions of the head 2. According to the embodiment, the head 2 can be locked in three tilted positions.

FIG. 2(a) shows the basic position of the head 2 while the electric shaver of the present invention is in use. The head 2 is in a pull shaving tilted position in which the head 2 is positioned generally sideways. FIG. 2(c) shows the head 2 in a border shaving tilted position, wherein the head 2 faces generally upward. FIG. 2(b) shows an intermediate tilted position between the two tilted positions.

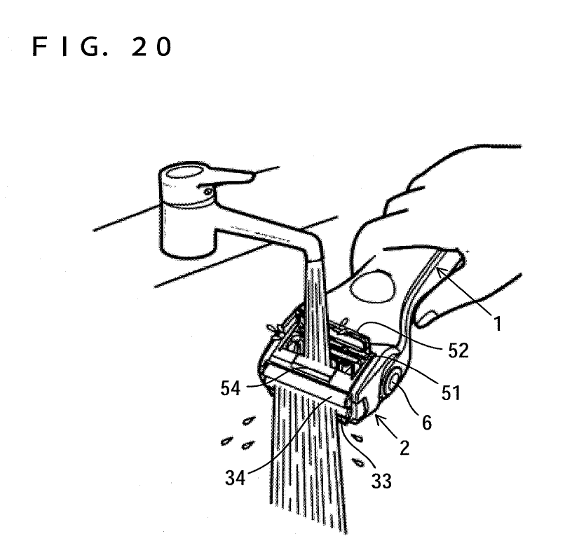

As shown in FIG. 20 and described previously, the tilted position of FIG. 2(c) for border shaving is suitable also for washing the interior of the shaver head 2.

The intermediate tilted position is suitable for pressure shaving because the elbow then need not be raised.

A line extending from the axis P1 of the handle 1 and passing through the head 2 makes with a tilt axis P2 of the head 2 an angle, which is about 80 degrees in the pull shaving tilted position, about 50 degrees in the intermediate tilted position, or about 20 degrees in the border shaving tilted position.

The axis P1 of the handle is the center of the tubular shaft serving as the handle 1.

The tilt axis P2 of the head 2 is an axis extending through the center of rotation (the center of tilting) of the head 2 and through the midpoint of the width of a rough shaving outer blade 33 positioned in the center of the head 2 to be described later.

With reference to FIG. 1, the handle 1 is in the form of a hollow shaft and enlarged into a generally T-shaped portion toward the head 2. The handle 1 is slender and rounded over the entire periphery thereof so as to be gripped like a pen.

The handle 1 is provided on each of its opposite sides with a grip portion 17 gently recessed in a circular-arc form and extending from the base end of the bracket arm 11 toward the base end of the handle 1.

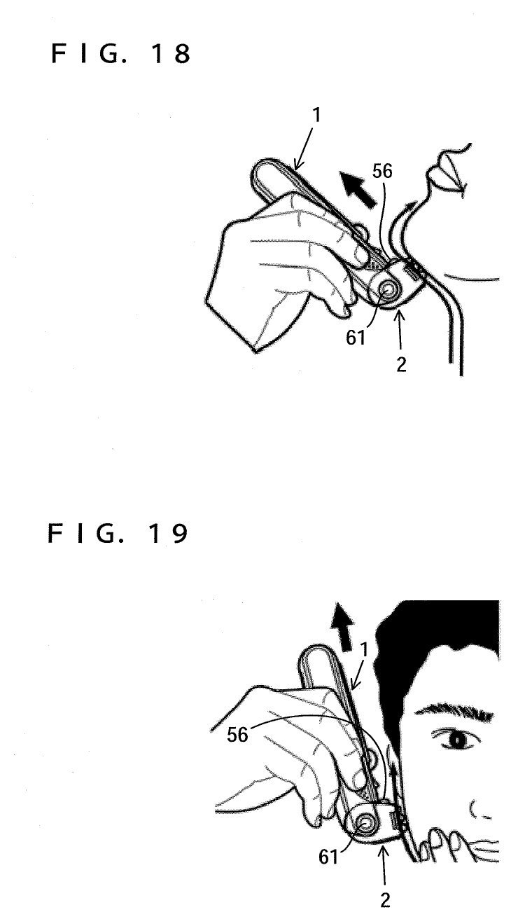

When the handle 1 is to be gripped at the portion thereof close to the bracket arms 11 from the backside of the handle 1, one of the grip portions 17 bears on the protuberance of the thumb, and the other grip portion 17 bears on the protuberances of the first and second fingers as shown in FIGS. 18 and 19.

The grip portions 17 are made of a nonslip material and/or have projections or indentations for preventing slippage.

The handle 1 is so shaped that the electric shaver can be held like the conventional T-shaped razor when the underside of the chin is to be shaved by pulling the shaver as shown in FIG. 18 or when the face side is to be similarly shaved as seen in FIG. 19. The shaver is therefore easy to use.

Between the bracket arms 11, 11, the handle 1 is provided at its upper end with a recessed circular-arc face 14 extending along the direction of rotation of the head 2 and with an eccentric rotary shaft 16 projecting upward and positioned slightly closer to the handle backside at the midportion of width of the handle end. The shaft 16 is eccentrically rotatable to oscillate a vibrator 4 reciprocatingly laterally.

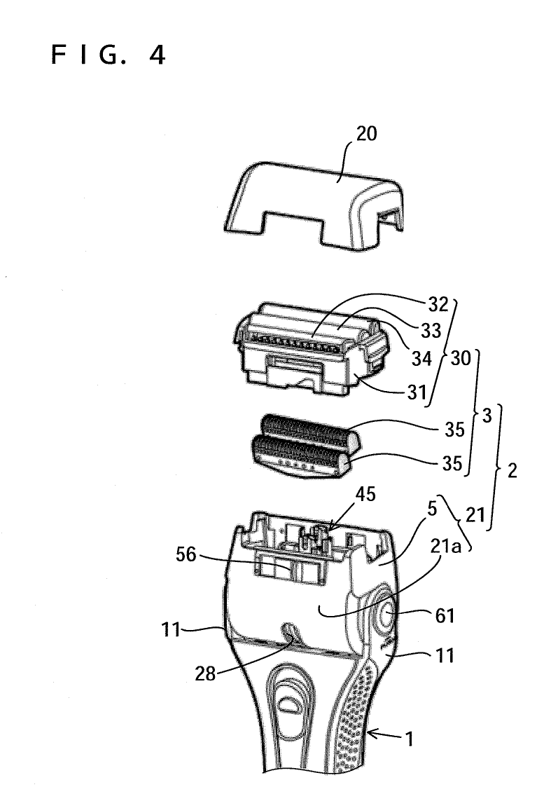

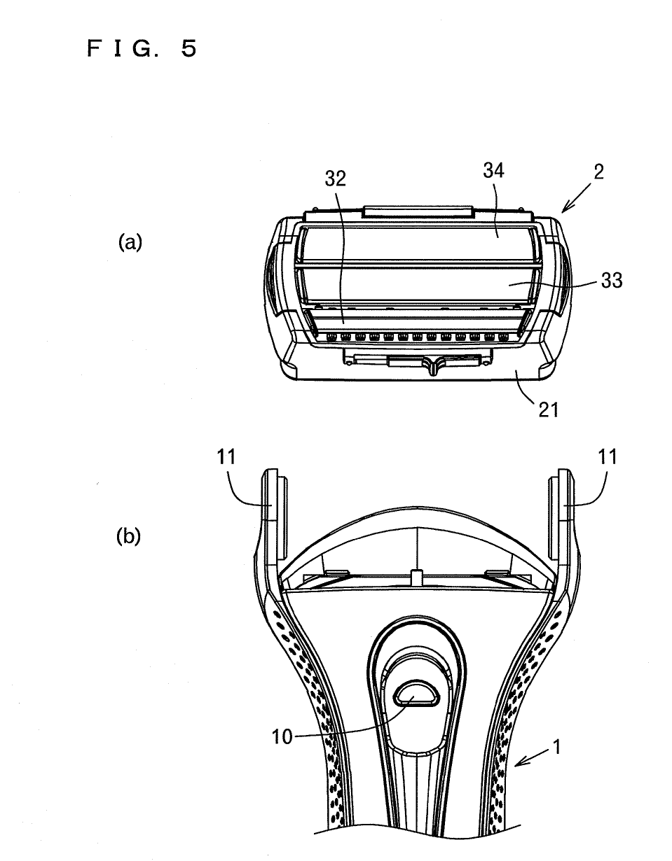

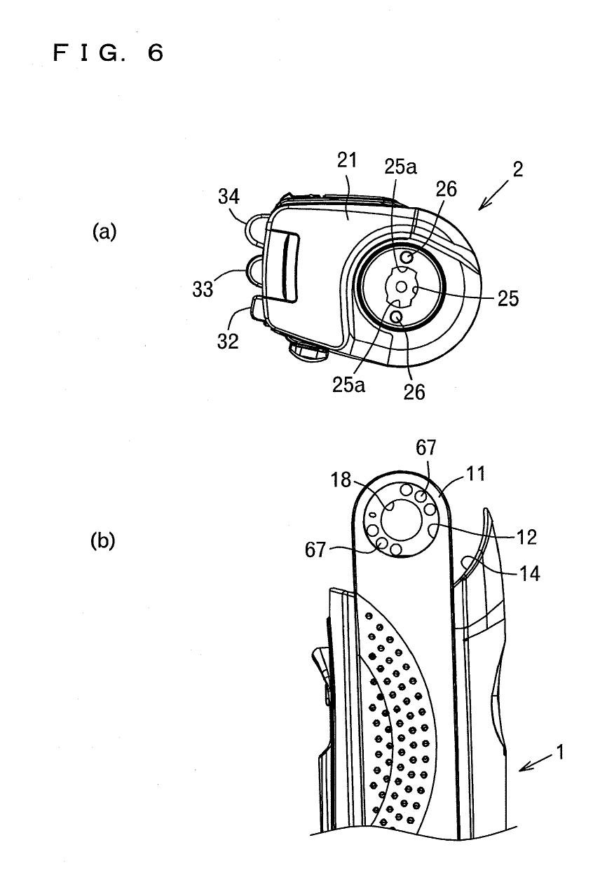

With reference to FIG. 4, the head 2 comprises a head body case 21, and the vibrator 4, inner blades 35, 35 and an outer blade cassette 30 which are housed in the head body case 21.

The head body case 21 comprises a lower case member 21a positioned on the handle 1 and pivotably provided between the bracket arms 11, 11, and a head upper case member 5 placed on the lower case member 21a and joined thereto.

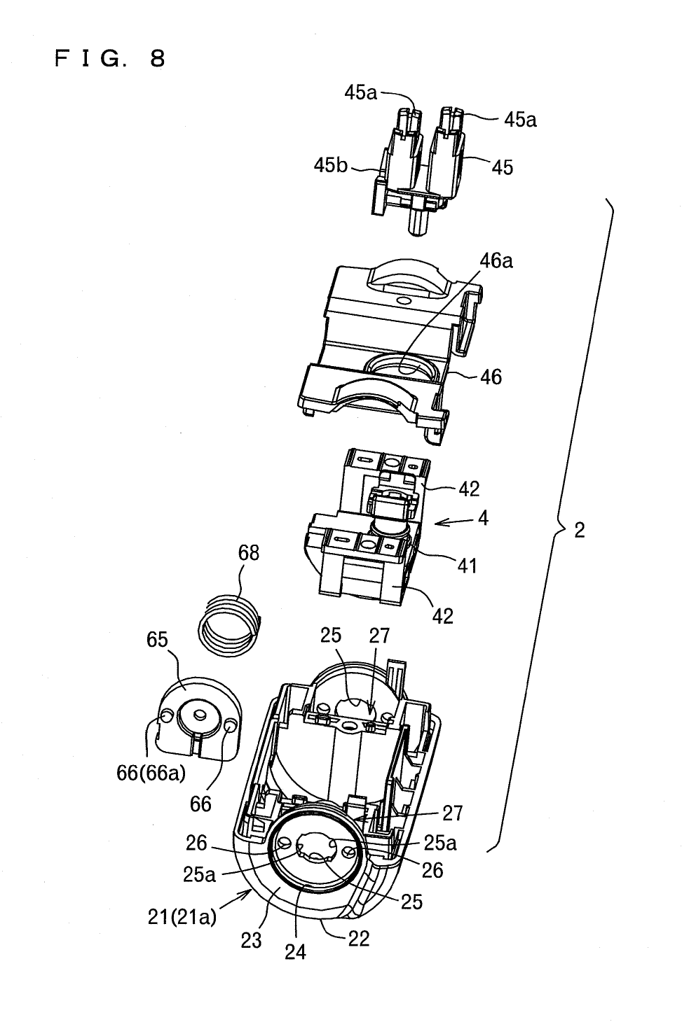

With reference to FIGS. 8 and 14, the lower case member 21a is in the form of a laterally elongated case which is open at its upper side, and has a bottom plate 22 in the form of a circular-arc wall centered about the center of rotation of the head 2 and shaped to extend along the recessed circular-arc face 14 at the upper end of the handle 1. The bottom plate 22 has a slit 28 extending in the direction of the circular arc for the eccentric rotary shaft 16 to loosely fit in.

The slit 28 extends over such a range that the bottom plate 22 will not interfere with the eccentric rotary shaft 16 when the head 2 is shifted from the pull shaving tilted position to the border shaving tilted position.

The lower case member bottom plate 22 has recessed step portions 29 lower than the inner surface of the plate 22 and extending over the entire length of the plate edges defining the slit 28.

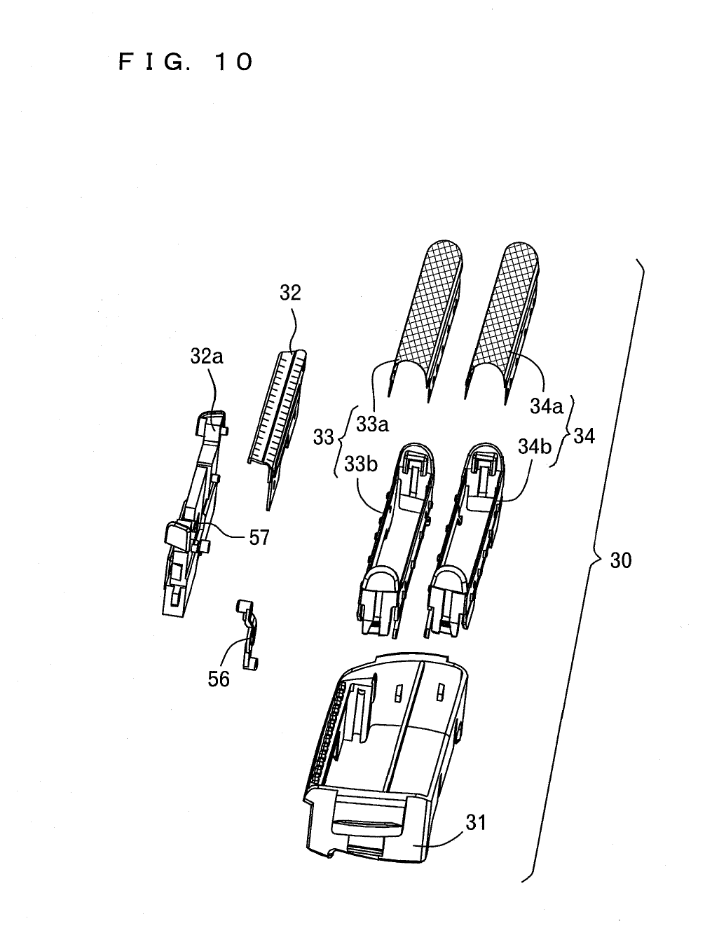

With reference to FIGS. 8 and 11, each of opposite ends of the lower case member 21a has a partitioned small compartment 27, and a circular recessed step portion 24 is concentrically formed in an end plate 23 of the case member 21a. A circular hole 25 is formed in the center of the step portion 24.

The hole 25 has cutouts 25a, 25a positioned symmetrically as spaced apart by 180 degrees about the center.

Guide holes 26 spaced apart by 180 degrees are formed symmetrically in the step portion 24 on opposite sides of the hole 25.

As shown in FIG. 8, the vibrator 4 coupled to the eccentric rotary shaft 16 is disposed in the lower case member 21a.

As in conventional electric shavers, the vibrator 4 has an inner blade mount 41 and flexible arm pieces 42, 42 at opposite ends of the mount 41. The arm pieces 42, 42 are fastened at their free ends to a mount boss (not shown) on the lower case member 21a with screws.

Projecting from the bottom of the inner blade mount 41 are parallel guide plates 42, 42 which are arranged orthogonal to the directions of reciprocation of the vibrator 4, with the eccentric rotary shaft 16 disposed slidably between the guide plates 42, 42.

The guide plates 43, 43 have respective circular-arc edges 43a extending along the curve of the bottom plate 22 of the lower case member 21a. Projecting outward from each of the guide plates 43 is a closing piece 44 extending along the circular-arc edge 43a.

The circular-arc edges 43a of the guide plates 43 fit in the recessed step portions 29 on opposite sides of the slit 28 in the bottom plate 22 of the lower case member 21a.

The guide plates 43, 43 are pushed laterally leftward or rightward by the eccentric rotation of the rotary shaft 16, whereby the vibrator 4 is oscillated longitudinally of the lower case member 21a. Despite the oscillation of the vibrator 4, the closing pieces 44, 44 close the recessed step portions 29, consequently closing the slit 28 and preventing extraneous matter from moving in or out through the slit 28.

The upper opening of the lower case member 21a is provided with a vibrator cover 46 for closing the opening. The cover 46 has an opening 46a corresponding in position to the vibrator 4 and provided with a rubber cap (not shown).

The vibrator 4 has a connector 45 disposed at an upper portion thereof and extending through the rubber cap.

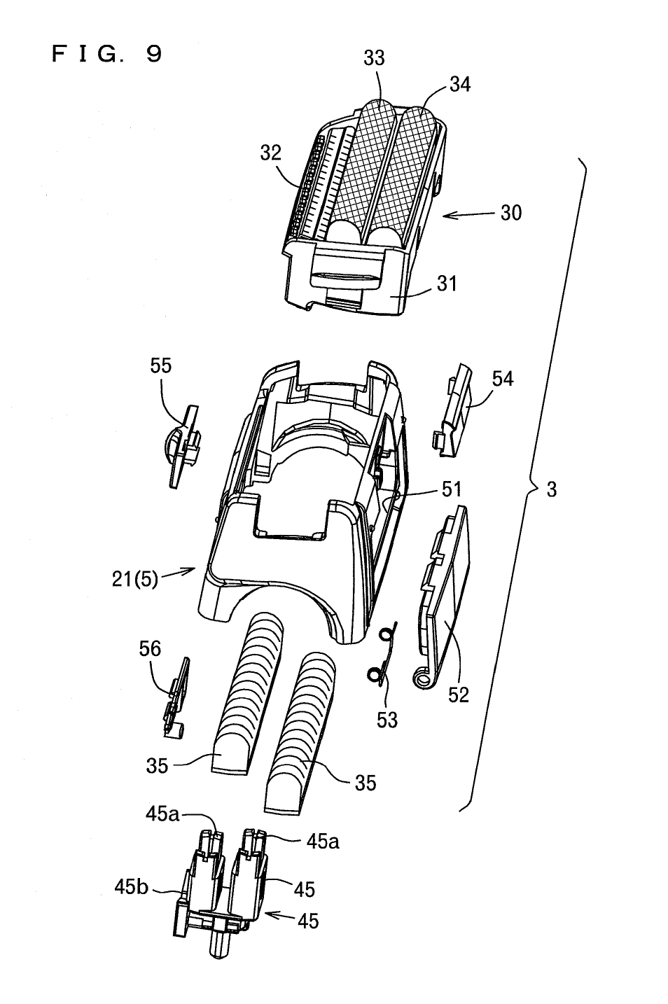

With reference to FIG. 9, the connector 45 has two mount legs 45a, 45a for mounting the inner blades 35, 35, and an engaging portion 45b for driving an outer blade 32 for border shaving.

As shown in FIG. 9, the blade unit 3 comprises two inner blades 35, 35 to be removably mounted on the legs 45a, 45a of the connector 45, the outer blade cassette 30 including two outer blades 33, 34 fittable over the inner blades 35, 35 and the border shaving outer blade 32, and the head upper case member 5 on the lower case member 21a.

Each inner blade 35 is a known one and comprises a blade plate prepared from a metal sheet having a row of slits by curving the blade plate to an inverted U shape in cross section (see, for example, JP2006-340938A).

The outer blade cassette 30 shown in FIGS. 9 and 10 has three laterally elongated outer blades 32, 33, 34 as arranged in parallel within a blade case 31 in the form of a laterally elongated frame which is open at its upper and lower sides. The rough shaving outer blade 33 is positioned between the border shaving outer blade 32 and the finish shaving outer blade 34, and these blades 32, 33, 34 are left exposed from the upper end opening of the blade case 31.

The rough shaving blade 33 and the finish shaving blade 34 each comprise a reticular blade 33a or 34a made of a thin metal sheet having a multiplicity of perforations and fixed to a laterally elongated frame 33b or 34b which is open at its upper and lower sides.

The border shaving outer blade 32 is made from a metal sheet by bending the sheet to an inverted L shape and having a multiplicity of cutouts in a row and formed at the bent portion to provide a cutting edge.

The border shaving outer blade 32 is attached to an auxiliary member 32a to be described below.

The outer blade cassette 30 is removably provided with a protective cover 20 as shown in FIG. 4.

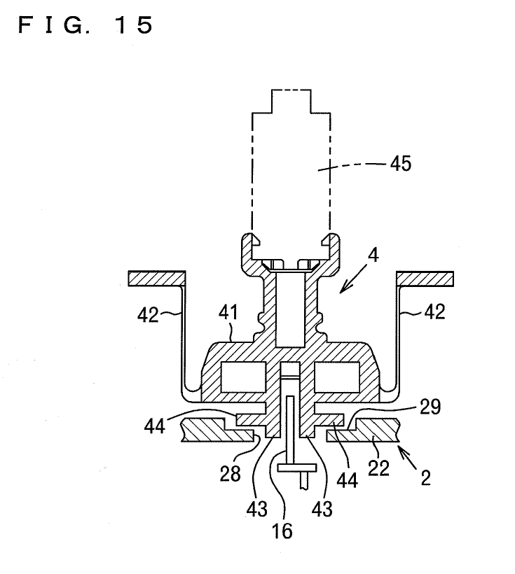

With reference to FIG. 16(a), the finish shaving outer blade 34 has a perforation pattern shown and providing a cutting edge. FIG. 16(b) is an enlarged view of one unit of perforation pattern.

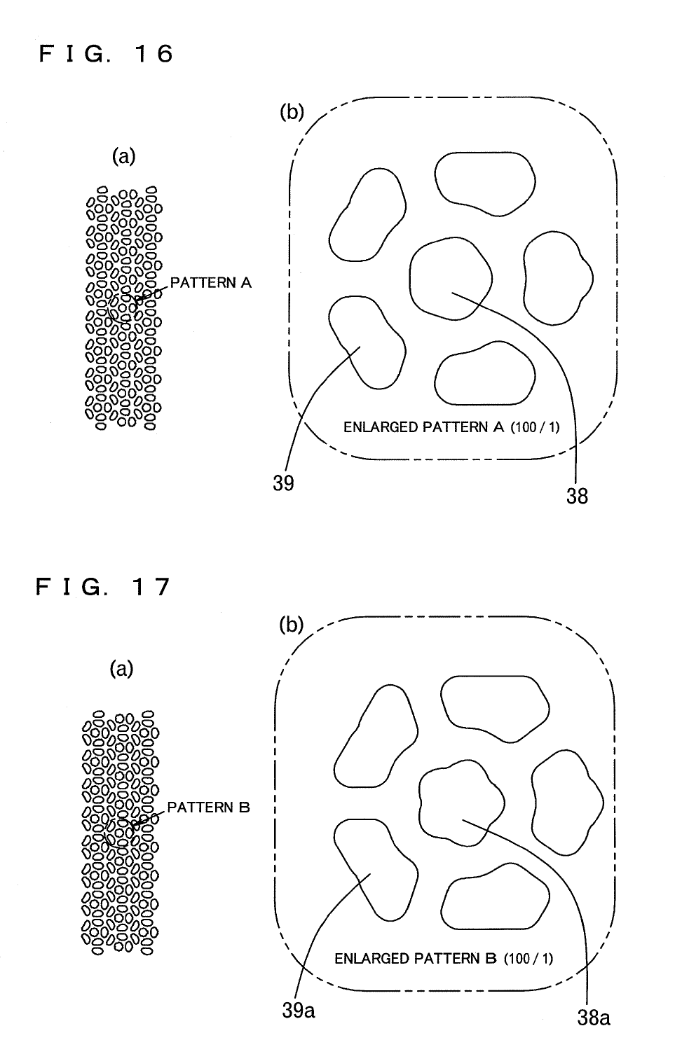

The rough shaving outer blade 33 has a perforation pattern shown in FIG. 17(a) and providing a cutting edge. FIG. 17(b) is an enlarged view of one unit of perforation pattern.

With both the rough shaving outer blade 33 and the finish shaving blade 34, each unit of perforation pattern has a central perforation 38 or 38a and five perforations 39 or 39a generally equidistantly arranged around the central perforation. The perforations 38, 39 of the finish shaving blade 34 are more rounded than those 38a, 39a of the rough shaving blade 38.

The border shaving outer blade 32 has the same perforation pattern as conventionally.

When water is applied to interior of the blade case 31, the border shaving blade 32 permits smoother passage of water therethrough than the rough shaving blade 33 or the finish shaving blade 34.

The auxiliary member 32a is incorporated in the blade case 31 for pushing up the border shaving outer blade 32 to a border shaving level. The border shaving blade 32 is attached to the auxiliary member 32a. The auxiliary member 32 is biased by a spring (not shown) toward such a direction as to move the border shaving blade 32 into the blade case 31.

The auxiliary member 32a is provided with a border shaving inner blade (not shown) slidable on the inner surface of the border shaving outer blade 32. This inner blade is coupled by a link 56 to the engaging portion 45b on the connector 45 and reciprocatingly slidable.

With the border shaving outer blade 32 in its lower end position as shown in FIG. 2(a), the border shaving outer blade 32, the rough shaving outer blade 33 and the finish shaving outer blade 34 increase in this order in the height of projection from the upper side opening 31a of the blade case 31, and the outer faces of these blades 32, 33, 34 are positioned generally on a plane F.

The head upper case member 5 shown in FIG. 9 is in the form of a laterally elongated frame which is open at its upper and lower sides. With the border shaving outer blade 32 positioned on the front side, the outer blade cassette 30 is placed into the case member 5 through the upper side opening thereof. In this state, the inner blades 35, 35 are slidable in contact with the respective inner surfaces of the rough shaving outer blade 33 and the finish shaving outer blade 34.

A push knob 55 for pushing up the border shaving outer blade 32 is laterally slidably provided on the front wall of the head upper case member 5.

As shown in a phantom line in FIG. 2(c), the outer blade 32 is used as pushed up for border shaving as in the prior art.

With the push knob 55 provided on the front wall of the head upper case member 5, the push knob 55 faces inward when the head 2 is tilted to the pull shaving position as shown in FIGS. 18 and 19. This obviates the likelihood that the push knob 55 will be moved inadvertently at a touch during pull shaving.

The head upper case member 5 has formed in its rear wall a laterally elongated large washing window 51 occupying at least half the rear wall area and closed with a lid 52, which is pivoted at opposite ends of its lower portion and biased toward an opening direction by a spring 53.

Disposed above the lid 52 of the case member 5 is a lock knob 54 which is slidable upward or downward. The lid 52 can be locked in a closed position by the lock knob 54 as moved down, or can be unlocked when the knob is moved up.

Each of opposite bracket arms 11 of the handle 1 has a circular recessed portion 12 on the outer side of its upper end and a circular protrusion 13 corresponding to the recessed portion 12 and provided on the inner side of the end. These protrusions 13, 13 rotatably fit into the respective circular recessed step portions 24 in opposite ends of the lower case member 21a.

With the bracket arms 11, 11 elastically deformed outward, the head 2 can be fitted into the space between the arms 11.

A circular hole 18 is formed in the center of the recessed portion 12 of the bracket arm 11. A sleeve 7 is inserted through the hole 18 and the hole 25 formed in the recessed step portion 24 of the lower case member 21a.

The sleeve 7 has retainers 71, 72 at opposite ends thereof. The retainer 71 is disposed at the outer end and is in the form of a flange. Retainers 72 are disposed at the inner end and project outward from symmetric positions 180 degrees away from each other.

The sleeve 7 is fitted in position, with the inner end retainers 72, 72 in phase with the cutouts 25a, 25a in the hole 25 of the lower case member 21a, and is then rotated, whereby the retainers 72, 72 are brought out of phase with the cutouts 25a, 25a. This prevents the sleeve 7 from slipping off, effectively precluding the head 2 from slipping out of the handle 1.

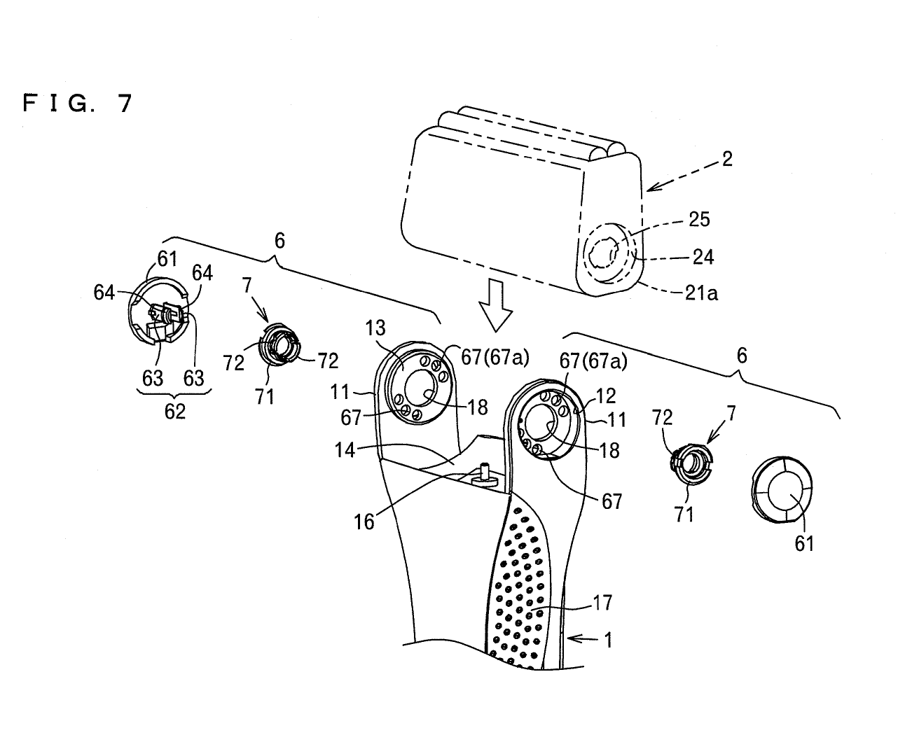

Lock means 6 is provided on both the bracket arm 11 and the head 2 for fixing the tilt angle of the head 2. Although FIG. 7 shows lock means 6 provided on each of the bracket arms 11, 11, the lock means may be provided on only one side.

With reference to FIGS. 7, 11 and 12, the lock means 6 comprises a lock plate 65 engageable with the bracket arm 11 by the engagement of engaging means 60 between a projection 66 and a cavity 67 for locking the head 2 at a tilt angle, and an unlocking button 61.

The unlocking button 61 fits into the recessed portion 12 in the bracket arm 11 and comprises a stem 62 projecting from the center of the button and slidably extending through the sleeve 7 into the small compartment 27 of the head 2.

The stem 62 comprises two stem pieces 63, 63 arranged in parallel at such a distance as to permit the stem to fit into the sleeve 7 tightly. Each of the stem pieces 63 has an outwardly hooked free end 64, which is engageable with the end face of the sleeve 7 for preventing the stem 62 from slipping off. Despite the presence of the hooked ends 64, the stem pieces 63 are elastically deformable, reducing the spacing between the stem pieces 63 and enabling the stem 62 to extend through the sleeve 7.

The stem 62 has an effective length, which is greater than the stroke length required for disengaging the engaging means 60.

The lock plate 65 of the embodiment has a lock pin 66a serving as the projection 66 of the engaging means 60. The bracket arm 11 has a lock bore 67a serving as the cavity 67 of the engaging means 60.

With reference to FIG. 7, the bracket arm 11 has in its recessed portion 12 three lock bores 67a as a group, and two groups of bores 67a are provided symmetrically in respective positions which are apart by 180 degrees.

The three lock bores 67a of each group as spaced apart correspond to the respective three tilted positions of the head 2 already mentioned.

With reference to FIG. 11, the lock plate 65 is accommodated in the small compartment 27 of the head 3. Two lock pins 66a are slidably inserted in the respective two guide bores 26 formed in the end plate 23 of the head 2.

The lock plate 65 is biased toward the unlocking button 61 by a spring 68, pushing the stem 62 of the button 61 outward at all times.

When the head 2 is locked at a specified angle, the lock pins 66a extend through the guide holes 26 and are fitted in the corresponding lock bores 67a in the bracket arm 11.

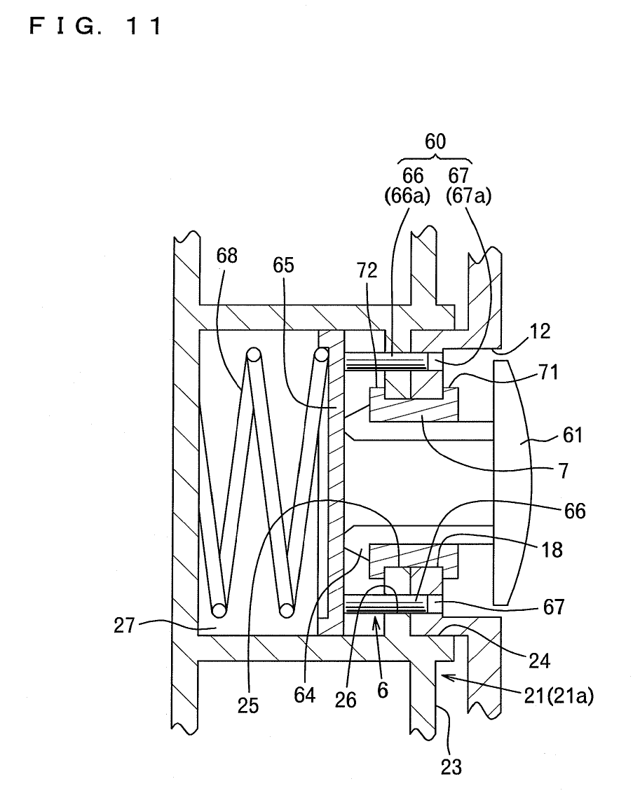

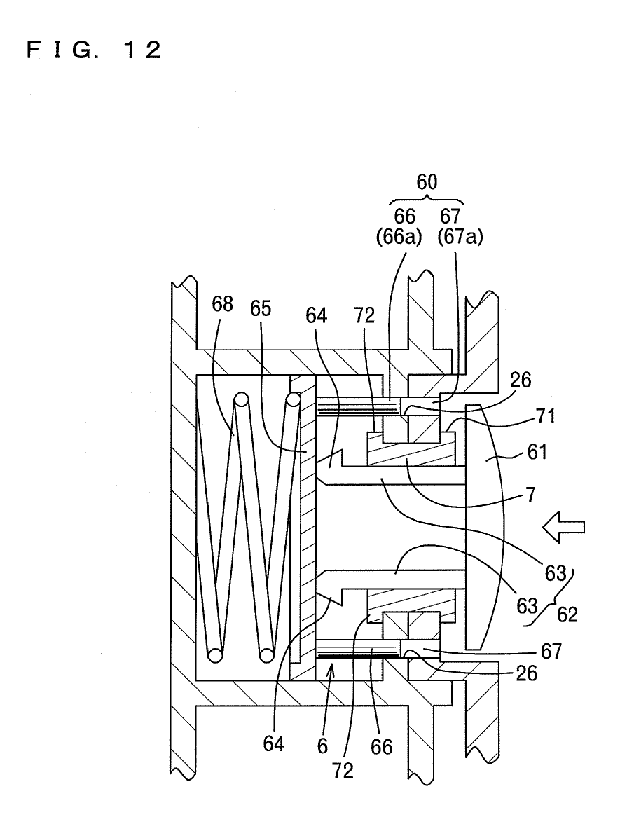

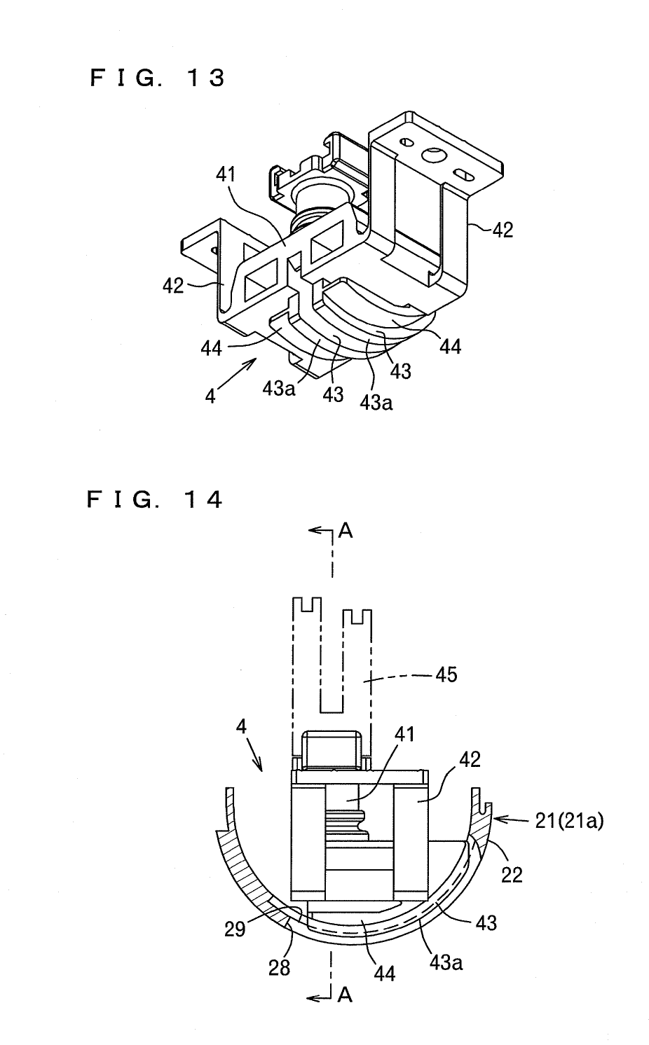

When the unlocking button 61 is pressed against the spring 68 as seen in FIG. 12, the stem 62 on the button 61 pushes the lock plate 65 inward, moving the lock pins 66a out of the lock bores 67a of the bracket arm 11 to release the head 2 from the tilted position.

In this state, the head 2 is rotatable (tiltable) about the sleeve 7 of the head 2. The head 2 is tilted and locked reliably at the next tilted position where the lock pins 66a engage in the corresponding lock bores 67a.

The unlocking button 61 directly presses the lock plate 65 so as to apply a pressure directly with its stem 62 without any loss.

When the free end of the stem 62 of the unlocking button 61 is adapted to prevent slipping off, the button can be always biased toward the direction of slipping off by the spring 68 through the lock plate 65, whereby the button 61 can be tensioned by the spring at all times and thereby prevented from backlashing.

Apparently the present invention can be modified or altered by one skilled in the art without departing from the spirit of the invention. Such modifications are included within the scope of the invention as defined in the appended claims.

What is claimed is:

1. An electric shaver comprising a head tiltably attached to an end of a handle, the head having a blade unit,
the head being tiltable with the handle thereby supported vertically until the blade unit is positioned sideways, the head being holdable as positioned sideways by lock means.

2. The electric shaver according to claim 1 wherein the handle is in the form of a shaft and enlarged into a generally T-shaped portion toward the head, and the enlarged portion has bracket arms projecting respectively from opposite ends thereof, the head being provided between the bracket arms.

3. The electric shaver according to claim 1 wherein the head can be locked in a plurality of tilted positions including a pull shaving tilted position which is a basic tilted position permitting the blade unit to be positioned sideways with the handle supported vertically and a border shaving tilted position permitting the blade unit to face generally upward.

4. The electric shaver according to claim 3 wherein the head in the pull shaving tilted position is inclined through about 80 degrees from an extension of an axis P1 of the handle extending through the head, and the head in the border shaving tilted position is inclined through about 20 degrees from the extension.

5. The electric shaver according to claim 1 wherein the handle has an eccentric rotary shaft projecting from the end thereof and coupled to a motor, and the head is tiltably provided between bracket arms projecting respectively from opposite sides of the end of the handle, the head comprising a head body case having a bottom portion adjacent the handle and curved toward the direction of tilting of the head, an outer blade cassette removably provided in the head body case, a vibrator reciprocatingly movable in directions orthogonal to the handle and engaging with the eccentric rotary shaft as loosely inserted through a bottom plate of the head body case, and inner blades slidable in contact with outer blades of an outer blade cassette from inside thereof and attached to and reciprocatingly movable with the vibrator, the vibrator having parallel guide plates orthogonal to the directions of reciprocation of the vibrator, the eccentric rotary shaft being interposed between and slidable in contact with the guide plates, each of the guide plates having a circular-arc edge extending along the curve of the head body bottom portion, a closing piece projecting outward from each of the guide plates and extending along the circular-arc edge, the bottom plate of the head having a slip with a width to avoid the interference of the bottom plate with the eccentric rotary shaft, the closing piece serving to close the slit even when the vibrator oscillates widthwise of the slit.

6. The electric shaver according to claim 1 wherein with the handle positioned vertically and with the head on an upper end of the handle positioned sideways, the blade unit has a border shaving outer blade, a rough shaving outer blade and a finish shaving outer blade which are arranged from below upward in this order, the outer blades having respective outer faces positioned generally on a plane F, and the plane F makes an angle of 10 to 20 degrees with an axis P1 of the handle, the finish shaving outer blade being remotest in position from the axis P1.

7. The electric shaver according to claim 4 wherein the head body case has a front wall facing toward the pull shaving tilted position and provided with a push knob for pushing up a border shaving outer blade to a border shaving position, and a rear wall provided with a washing window and a lid for closing the window.

8. The electric shaver according to claim 5 wherein the head body case has a front wall facing toward the pull shaving tilted position and provided with a push knob for pushing up a border shaving outer blade to a border shaving position, and a rear wall provided with a washing window and a lid for closing the window.
